(19) United States
(12) Patent Application Publication
(10) Pub. No.: US 2014/0320299 A1
(43) Pub. Date: Oct. 30, 2014

(54) PROTECTION DEVICE AND POWER DISTRIBUTION UNIT INCLUDING THE SAME

(71) Applicant: ALCATEL-LUCENT USA, INC., Murray Hill, NJ (US)

(72) Inventors: Arthur F. Kirk, Naperville, IL (US); Thomas R. Perzentka, JR., Naperville, IL (US); Robert M. Wentzel, Naperville, IL (US); Ramfis Rivera-Colon, Naperville, IL (US)

(73) Assignee: Alcatel-Lucent USA, Inc., Murray Hill, NJ (US)

(21) Appl. No.: 13/870,515

(22) Filed: Apr. 25, 2013

(51) Int. Cl. H01H 9/54

(52) U.S. Cl. CPC H01H 9/54
USPC 340/691.8; 361/626

(57) ABSTRACT

An alarm switching matrix, a power distribution unit and a method of operating a power distribution unit are disclosed. In one aspect, an alarm switching matrix for use with multiple types of overcurrent protection devices is provided. In one embodiment, the alarm switching matrix includes: (1) a power circuit coupled to a power input terminal and configured to provide a supply voltage to alarm contact terminals for a circuit breaker and (2) an alarm circuit coupled to an alarm output terminal and a fuse alarm contact terminal that is one of the alarm contact terminals, wherein the alarm circuit is configured to deliver alarm signals to the alarm output terminal from both a circuit breaker connected to the alarm contact terminals and a fuse connected to the fuse alarm contact terminal.

### TECHNICAL FIELD

This disclosure is directed, in general, to protection devices for electrical systems.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Electrical devices, such as circuit breakers and fuses, are used to protect electrical equipment from overloaded or overcurrent conditions. Though similar in function, a circuit breaker and a fuse often operate differently. When an overcurrent condition occurs, a circuit breaker will operate or “trip” to stop the flow of electricity in a circuit and protect the circuit from damage. The circuit breaker can then be reset after clearing the overcurrent condition. In contrast, a fuse is cleared to stop the flow of electricity in a circuit when an overcurrent condition occurs. Instead of being reset, the cleared fuse is replaced.

Circuit breakers and fuses are used in a variety of electrical devices, such as service panels and power distribution units, to distribute electrical power and provide overcurrent protection. Power distribution units are commonly employed by a wide range of global customers in various industries, such as telecommunications. A power distribution unit receives a power input, a line voltage, and distributes power therefrom to various load circuits. For example, a power distribution unit is often used to distribute high overcurrent protected power feeds to racks of computer and networking equipment located within a data center. The feeds to individual computer and networking equipment are branched, becoming low overcurrent protected power feeds. Circuit breakers and fuses are used to provide the overcurrent protection.

### SUMMARY

In one aspect, an alarm switching matrix for use with multiple types of overcurrent protection devices is provided. In one embodiment, the alarm switching matrix includes: (1) a power circuit coupled to a power input terminal and configured to provide a supply voltage to alarm contact terminals for a circuit breaker and (2) an alarm circuit coupled to an alarm output terminal and a fuse alarm contact terminal that is one of the alarm contact terminals, wherein the alarm circuit is configured to deliver alarm signals to the alarm output terminal from both a circuit breaker connected to the alarm contact terminals and a fuse connected to the fuse alarm contact terminal.

In yet another aspect, a method of operating a power distribution unit is disclosed. In one embodiment, the method includes: (1) receiving a supply voltage at alarm terminals that are for a circuit breaker, wherein one of the alarm terminals is a fuse alarm terminal for a fuse alarm contact, (2) generating a breaker alarm signal when the alarm terminals are connected, (3) generating a fuse alarm signal when the fuse alarm terminal receives a power source and (4) transmitting both the breaker alarm signal and the fuse alarm signal on a single alarm circuit coupled to the fuse alarm terminal.

In still yet another aspect, the disclosure provides a power distribution unit. In one embodiment, the power distribution unit includes a protection receptacle, configured to receive both a circuit breaker and a fuse, and including a pair of circuit breaker alarm terminals configured to receive alarm contacts of a circuit breaker, wherein one of the circuit breaker alarm terminals is also configured to receive a fuse alarm contact.

### BRIEF DESCRIPTION OF THE DRAWINGS

For a more complete understanding of the disclosure, reference is now made to the following descriptions taken in conjunction with the accompanying drawings, in which:

FIG. 1 is a diagram of an embodiment of a power distribution unit constructed according to the principles of the disclosure;

FIG. 2 is a block diagram of an embodiment of a power distribution unit constructed according to the principles of the disclosure;

FIG. 3 is a schematic diagram of an embodiment of an alarm switching matrix constructed according to the principles of the disclosure; and

FIG. 4 is a flow diagram of an embodiment of a method of operating a power distribution unit carried out according to the principles of the invention.

In the Figures and text, similar or like reference symbols indicate elements with similar or the same functions and/or structures.

In the Figures, the relative dimensions of some features may be exaggerated to more clearly illustrate one or more of the structures or features therein.

Herein, various embodiments are described more fully by the Figures and the Detailed Description. Nevertheless, the inventions may be embodied in various forms and are not limited to the embodiments described in the Figures and Detailed Description of Illustrative Embodiments.

### DETAILED DESCRIPTION

Typically, consumers have different requirements for the type of overcurrent protection devices that are used in a power distribution unit. Thus, service companies for the various customers often maintain two different types of power distribution units. Some overcurrent protection device manufacturers offer power distribution units with dedicated receptacles for both circuit breakers and fuses in the same physical package. However, the customer is restricted to the number of fuse and circuit breaker receptacles determined by the manufacturers. As such, the customer has to maintain an inventory including both types of protection devices and is restricted to the type of protection device that can be used for each load circuit connected to the power distribution unit.

For a power distribution unit to have and support both circuit breakers and fuses, the processing of cleared fuses or tripped circuit breaker alarm signals needs to be addressed. When a circuit breaker trips, the circuit breaker is first manually reset after the fault is removed from the load circuit. No more tripping should occur. To do this effectively and if the panel contains a multitude of adjacent circuit breakers, the tripped circuit breaker should be easily visually identified. This can be accomplished by viewing the circuit breaker switch, lighting a respective visual identifier, such as a bulb, Light Emitting Diode (LED) or colored flag, or by sending an alarm signal to an alarm controller connected to the power distribution unit. If a fuse clears, that fuse location should also be easy to identify by viewing the cleared fuse, lighting a LED and/or reporting the fault to the alarm controller.

The different types of overcurrent protection devices use one or two alarm contacts to perform the alarming function. Interchanging one device with another is difficult since circuit breaker manufacturers typically provide an isolated set of contacts for alarm signals that are connected to a power supply. In contrast, fuse manufacturers generate an alarm signal with a single contact and contact closure sourced from the line or load side of the fuse. Generally this contact closure is generated by a small pilot fuse designed to clear much more quickly than the load fuse.

Both devices generate alarm signals differently due to different physical alarming schemes and alarm contacts. As such, it is difficult to provide a single mechanism in a single power distribution unit that supports alarming for both types of overcurrent protection devices when used at the same time.

The disclosure advantageously provides a power distribution unit with universal overcurrent protection receptacles that are designed to receive both a circuit breaker and a fuse. Thus, instead of a power distribution unit having receptacles configured to receive only one type of overcurrent protection device, the disclosure provides a single receptacle that is configured to receive more than one type of overcurrent protection device.

Accordingly, rather than employ two different types of power distribution units, a single power distribution unit is provided that can support both fuses and circuit breakers, including the alarm function. A customer, such as a data center owner, can then determine the type of protection device to use for each protected circuit of a power distribution unit. The disclosed protection scheme and device, therefore, provides cost savings and flexibility.

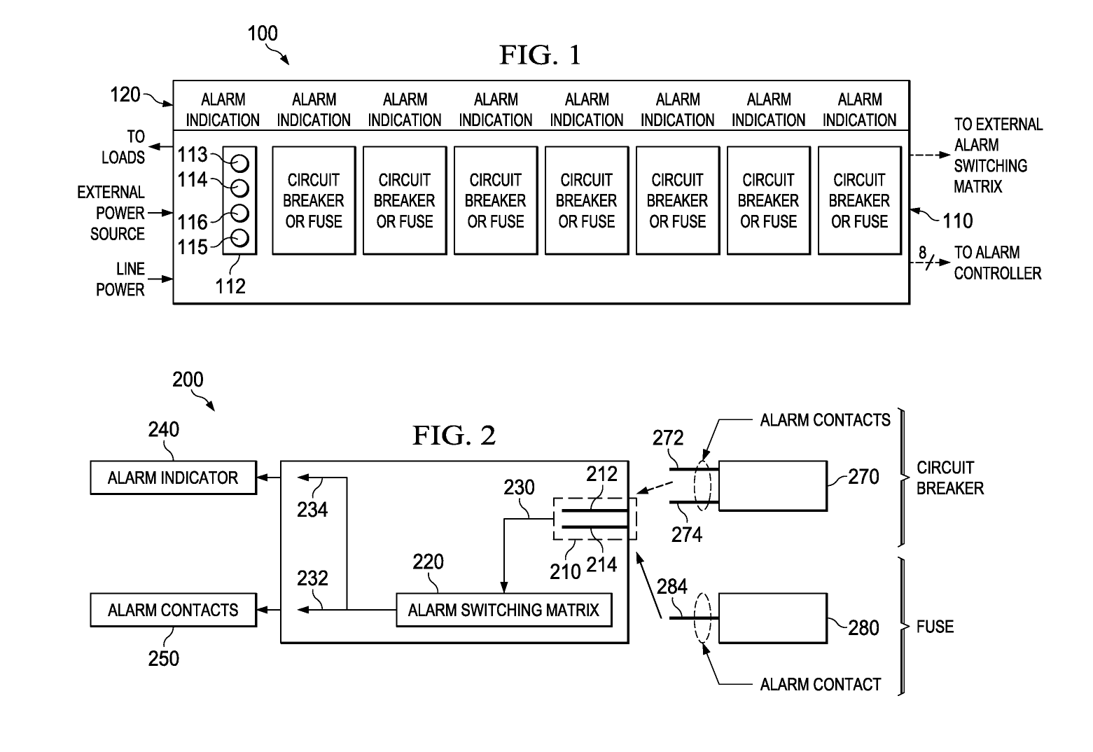

FIG. 1 is a front view of an embodiment of a power distribution unit 100 constructed according to the principles of the disclosure. The power distribution unit 100 can be implemented as a rack-mounted device. In other embodiments, the power distribution unit 100 is a self-supporting device that, for example, can be positioned on a floor or a table.

The power distribution unit 100 includes a plurality of universal overcurrent protection receptacles that are generally designated 110. The power distribution unit 100 also includes alarm indicators that are generally designated 120. The power distribution unit 100 includes eight overcurrent protection receptacles 110 and eight corresponding alarm indicators 120. Each of the overcurrent protection receptacles 110 are designed to protect a single load circuit and each of the alarm indicators 120 are configured to provide an indication of a fault on the corresponding load circuit. The alarm indicators 120 can be conventional indicators such as LEDs. In other embodiments, other types of visual indicators can be used. One skilled in the art will understand that the number of overcurrent protection receptacles and alarm indicators can vary in different embodiments and may be determined by a particular application or physical characteristics of a power distribution unit. As such, more or less than eight overcurrent protection receptacles or alarm indicators can be employed in the various embodiments disclosed herein.

The universal overcurrent protection receptacles 110 are configured to receive both a circuit breaker and a fuse to protect a circuit. Thus, either a fuse or a circuit breaker can be used in each of the universal overcurrent protection receptacles 110 to provide overcurrent protection. A single one of the overcurrent protection receptacles 110 is designated as a representative overcurrent protection receptacle 112 and will be discussed further in more detail. The overcurrent protection receptacle 112 includes a load terminal 113 and a line terminal 115 configured to receive load and line contacts, respectively, from both a circuit breaker and a fuse. The load terminal 113 is coupled to a load terminal block (not illustrated in FIG. 1) that is configured to be coupled to a load circuit. The line terminal 115 is coupled to a line terminal block (not illustrated in FIG. 1) that is configured to be coupled to an input line power voltage. The load and line terminals 113, 115, can be conventionally spaced, sized, shaped and connected to the load circuit and the input line power.

The overcurrent protection receptacle 112 also includes a pair of circuit breaker alarm terminals, designated 114 and 116, that are configured to receive alarm contacts of a circuit breaker. The circuit breaker alarm terminal 116 is also configured to receive a fuse alarm contact of a fuse. In other figures included herein, the circuit breaker alarm terminal 114 is referred to as a top alarm terminal and circuit breaker alarm terminal 116 is referred to as a middle alarm terminal. An alarm switching matrix, which is not illustrated in FIG. 1, is coupled to the pair of circuit breaker alarm terminals 114, 116, and is configured to isolate circuit breaker alarm signals from fuse alarm signals that are generated therefrom. In one embodiment, the alarm switching matrix is included as part of the power distribution unit 100. In another embodiment, the alarm switching matrix is located outside of the power distribution unit 100. For example, the alarm switching matrix can be located on or a part of an alarm control panel associated with the power distribution unit 100. In either embodiment, conventional conductors can be employed to connect the circuit breaker alarm terminals 114, 116, to the alarm switching matrix. A dashed arrow is illustrated in FIG. 1 to represent the embodiment wherein the alarm switching matrix is external to the power distribution unit 100. A dashed arrow is also used to represent the embodiment when the alarm switching matrix is located within the power distribution unit 100 and an alarm circuit connects each of the middle alarm terminals of the universal overcurrent protection receptacles 110 to an alarm controller.

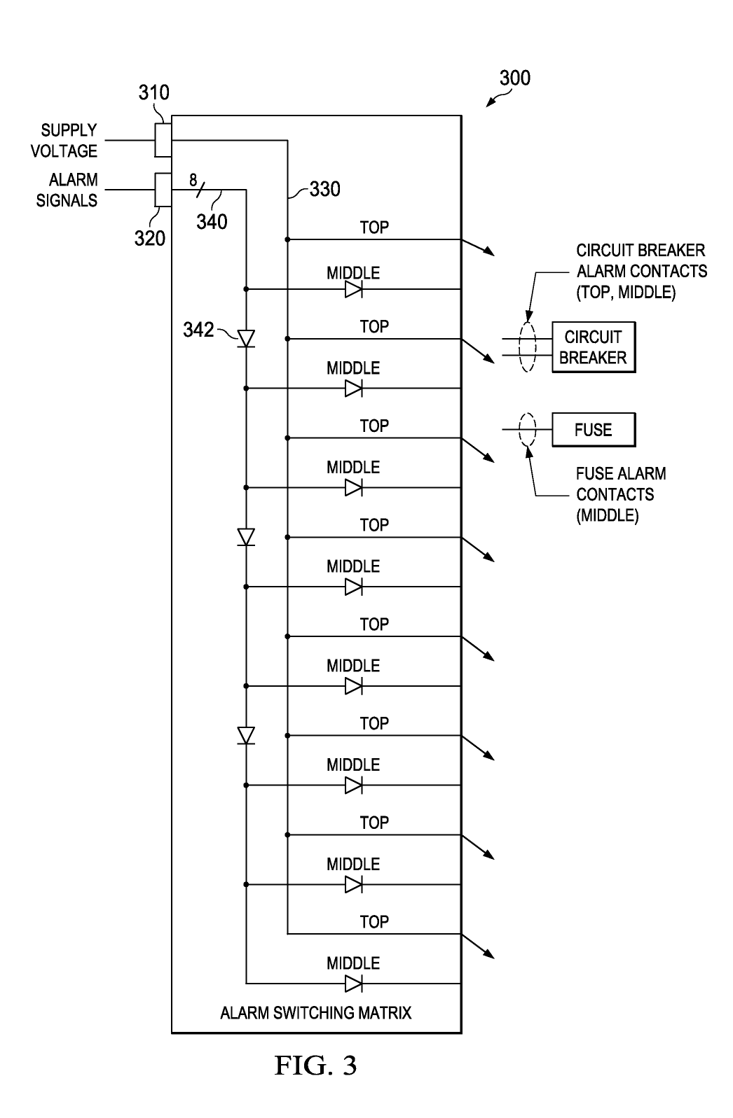

FIG. 3 provides more details of an embodiment of an alarm switching matrix. FIG. 2 illustrates an embodiment wherein the alarm switching matrix is included within a power distribution unit.

FIG. 2 is a block diagram of an embodiment of a power distribution unit 200 constructed according to the principles of the disclosure. The power distribution unit 200 includes a universal overcurrent protection receptacle 210, a switching matrix 220 and connecting circuitry 230, 232 and 234. To avoid confusion, a single universal overcurrent protection receptacle 210 is illustrated that does not include line and load terminals. One skilled in the art will understand that the power distribution unit 200 can include multiple universal overcurrent protection receptacles. As such, the connecting circuitry 230 would include the necessary conductors to couple each one to the switching alarm matrix 220 and the connecting circuitry 232 and 234 would include the necessary conductors for connecting to the corresponding alarm contacts and alarm indicators. For example, if there were eight universal overcurrent protection circuits, then there would be eight pairs of conductors for the connecting circuitry 230 and eight conductors for the connecting circuitry 232 and 234. The connecting circuitry 230, 232 and 234 can be conventional conductors and connectors.

The universal overcurrent protection receptacle 210 includes circuit breaker alarm terminals designated as a top alarm terminal 212 and a middle alarm terminal 214. The top and middle alarm terminals 212, 214, can be the circuit breaker alarm terminals 114, 116, of FIG. 1. Accordingly, the top and middle alarm terminals 212, 214, are configured to receive alarm contacts 272 and 274 from circuit breaker 270. Additionally, middle alarm terminal 214 is also configured to receive alarm contact 284 of fuse 280. Thus, the universal overcurrent protection receptacle 210 includes one alarm terminal, the middle alarm terminal 214 that is designated to receive both a fuse alarm contact and a circuit breaker alarm contact depending on the type of protection device that is selected to be used.

The top and middle alarm terminals 212, 214, are connected to the alarm switching matrix 230 by the connecting circuit 230. The alarm switching matrix 230 is configured to identify either a tripped circuit breaker or a cleared fuse coupled to the universal overcurrent protection receptacle 210. Additionally, the alarm switching matrix 230 is configured to isolate circuit breaker alarm signals from fuse alarm signals that are generated from the top and middle alarm terminals 212, 214, or from just the middle alarm terminal 214.

The power distribution unit 200 is illustrated in an environment including external contacts to an alarm indicator 240 and alarm contacts 250. The alarm indicator 240 is configured to indicate a circuit breaker trip or cleared fuse at the universal overcurrent protection receptacle 210. The alarm contacts 250 are configured to generate an alarm at, for example, an alarm controller. The alarm indicator 240 and alarm contacts 250 can be conventional components. In one embodiment, the alarm indicator 240 and the alarm contacts 250 are part of an alarm control circuit board that can be used to alert a data center.

FIG. 3 is a schematic diagram of an embodiment of an alarm switching matrix 300 constructed according to the principles of the disclosure. The alarm switching matrix 300 can be located within a power distribution unit, such as the power distribution units 100 or 200. In some embodiments, the alarm switching matrix 300 can be part of an alarm control circuit board and located external to a power distribution unit.

The alarm switching matrix 300 includes a power input terminal 310 and an alarm output terminal 320. The power input terminal 310 is configured to receive a supply voltage from an external power source. In one embodiment, the external power source is a power module of an alarm control circuit board. The external power source may provide a supply voltage of 48 volts such as used in the telecommunications industry. Other supply voltages may be used in other applications.

The alarm output terminal 320 is configured to provide alarm signals to indicate a circuit breaker trip or a cleared fuse. The alarm output terminal 320 can be coupled to alarm indicators, alarm contacts or both. The power input terminal 310 and the alarm output terminal 320 can be conventional components typically employed in, for example, the telecommunications industry.

The alarm switching matrix 300 also includes a power circuit 330 and an alarm circuit 340. The power circuit 330 is configured to couple the power input terminal 310 to an alarm contact terminal, i.e., the top alarm terminal, to provide the supply voltage to a circuit breaker alarm contact. The alarm circuit 340 is configured to couple the alarm output terminal 320 to a circuit breaker/fuse alarm contact terminal, i.e., the middle alarm terminal of the alarm contact terminals, to provide a path for alarm signals.

The alarm circuit 340 is configured to deliver alarm signals to the alarm output terminal 320 from both a circuit breaker connected to the alarm contact terminals (top and middle) and a fuse connected to the fuse alarm contact terminal (middle). The alarm circuit 340 includes diodes that are positioned to control signal flow. A representative one of the diodes is designated 342. The diodes may be conventional diodes such as a 1N4004 diode. The type of diodes can vary depending on a particular application.

The alarm switching matrix 300 allows alarms to be detected the same way from tripped circuit breakers or cleared fuses. Both over current devices use one or two alarm terminals. However, both devices generate alarms in different manners.

The fuse module typically has only one alarm contact. The fuse module generates the alarm signal by applying the line or load voltage to the contact when the fuse blows. Typically an indicator fuse is used to supply the alarm contact with the line or load voltage.

The circuit breaker has two alarm contacts. These contacts are completely isolated from any line or load voltages. One contact is connected to an external power supply. An alarm is generated when the contact closes and applies the supply voltage from the external power supply to the remaining contact.

For a power distribution unit to be compatible with both fuses and circuit breakers as disclosed herein, the external power supply voltage used for the circuit breaker alarms is isolated from contact with the line or load voltage used for signaling a cleared fuse. Yet, they both must provide a signal to the same alarming controller.

Compatibility between both overcurrent protection devices is accomplished by using the alarm switching matrix 300 for the alarm signals from both a circuit breaker and a fuse. The alarm switching matrix 300 isolates generation of the circuit breaker alarm signals from the generation of the fuse alarm signals. Both alarm signals enable an alarm controller to receive alarms from either cleared fuses or tripped circuit breakers. The mechanism allows both circuit breakers and fuses to be equipped in the same power distribution unit and provide safe and reliable overcurrent protection and fault detection.

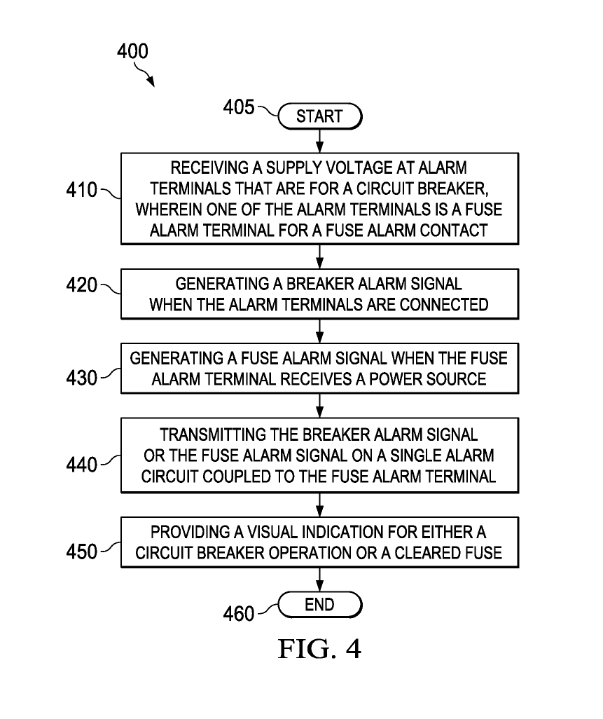

FIG. 4 is a flow diagram of an embodiment of a method 400 of operating a power distribution unit carried out according to the principles of the invention. The power distribution unit includes universal overcurrent protection receptacles. Additionally, the power distribution unit includes or is coupled to an alarm switching matrix. The method may be used during testing of the power distribution unit by, for example, a manufacturer of the power distribution unit. The method begins in a step 405.

In a step 410, a supply voltage is received at alarm terminals for a circuit breaker, wherein one of the alarm terminals is a fuse alarm terminal for a fuse alarm contact.

A breaker alarm signal is generated in a step 420 when the alarm terminals are connected. In a step 430 a fuse alarm signal is generated when the fuse alarm terminal receives a power source. A line voltage or a load voltage may be the power source.

The breaker alarm signal or the fuse alarm signal, whichever one is generated, is transmitted on a single alarm circuit coupled to the fuse alarm contact terminal in a step 440. In some embodiments, if both the breaker alarm signal and the fuse alarm signal are generated then both are transmitted using the single alarm circuit. Multiple of the breaker alarm signals and/or fuse alarm signals can be generated and transmitted using the same single alarm circuit. In some embodiments, this may be done simultaneously.

In a step 450, a visual indication for either a circuit breaker operation or a cleared fuse is provided. Multiple visual indications can be provided at the same time to correspond to multiple circuit breaker operations and/or cleared fuses. The method 400 then ends in a step 460.

The description and drawings merely illustrate the principles of the inventions. It will thus be appreciated that those skilled in the art will be able to devise various arrangements that, although not explicitly described or shown herein, embody the principles of the inventions and are included within its scope. Furthermore, all examples recited herein are principally intended expressly to be for pedagogical purposes to aid the reader in understanding the principles of the inventions and concepts contributed by the inventor(s) to furthering the art, and are to be construed as being without limitation to such specifically recited examples and conditions. Moreover, all statements herein reciting principles, aspects, and embodiments of the inventions, as well as specific examples thereof, are intended to encompass equivalents thereof. Additionally, the term, “or,” as used herein, refers to a non-exclusive or, unless otherwise indicated. Also, the various embodiments described herein are not necessarily mutually exclusive, as some embodiments can be combined with one or more other embodiments to form new embodiments.

Those skilled in the art to which the invention relates will appreciate that other and further additions, deletions, substitutions and modifications may be made to the described embodiments without departing from the scope of the invention.

What is claimed is:

1. An alarm switching matrix for use with multiple types of overcurrent protection devices, comprising:
a power circuit coupled to a power input terminal and configured to provide a supply voltage to alarm contact terminals for a circuit breaker; and
an alarm circuit coupled to an alarm output terminal and a fuse alarm contact terminal that is one of said alarm contact terminals, wherein said alarm circuit is configured to deliver alarm signals to said alarm output terminal from both a circuit breaker connected to said alarm contact terminals and a fuse connected to said fuse alarm contact terminal.

2. The alarm switching matrix as recited in claim 1 wherein an alarm signal from said circuit breaker is isolated from an alarm signal from said fuse.

3. The alarm switching matrix as recited in claim 1 wherein said supply voltage is separate from a power source for signaling an alarm signal from said fuse.

4. The alarm switching matrix as recited in claim 3 wherein said power source is a line or load voltage connected to said fuse.

5. The alarm switching matrix as recited in claim 1 wherein said power circuit is coupled to multiple circuit breaker alarm contact terminal pairs and said alarm circuit is coupled to multiple fuse alarm contact terminals.

6. The alarm switching matrix as recited in claim 5 wherein said alarm circuit includes a separate connection to each of said multiple fuse alarm contact terminals.

7. The alarm switching matrix as recited in claim 1 wherein said alarm switching matrix is implemented as a circuit board.

8. A method of operating a power distribution unit, comprising:
receiving a supply voltage at alarm terminals that are for a circuit breaker, wherein one of said alarm terminals is a fuse alarm terminal for a fuse alarm contact;
generating a breaker alarm signal when said alarm terminals are connected;
generating a fuse alarm signal when said fuse alarm terminal receives a power source; and
transmitting both said breaker alarm signal and said fuse alarm signal on a single alarm circuit coupled to said fuse alarm terminal.

9. The method as recited in claim 8 wherein said alarm terminals are connected when said circuit breaker closes or when said fuse is cleared.

10. The method as recited in claim 8 wherein said power source is a line voltage or a load voltage connected to said fuse.

11. The method as recited in claim 8 wherein said method is performed during testing of said power distribution unit.

12. The method as recited in claim 8 wherein said breaker alarm signal is isolated from said fuse alarm signal.

13. The method as recited in claim 8 wherein said supply voltage is isolated from said power source.

14. The method as recited in claim 8 further comprising providing a visual indication for either a circuit breaker operation or a cleared fuse.

15. A power distribution unit, comprising:
a protection receptacle configured to receive both a circuit breaker and a fuse, said protection receptacle including:
a pair of circuit breaker alarm terminals configured to receive alarm contacts of a circuit breaker, wherein one of said circuit breaker alarm terminals is also configured to receive a fuse alarm contact.

16. The power distribution unit as recited in claim 15 wherein said protection receptacle further includes a line terminal and a load terminal configured to receive line and load contacts from both said circuit breaker and said fuse.

17. The power distribution unit as recited claim 15 further including an alarm switching matrix configured to isolate circuit breaker alarm signals from fuse alarm signals.

18. The power distribution unit as recited in claim 17 wherein said alarm switching matrix includes:
a power circuit coupled to a power input terminal and configured to provide a supply voltage to said circuit breaker alarm terminals; and
an alarm circuit coupled to an alarm output terminal and said fuse alarm terminal, wherein said alarm circuit is configured to deliver alarm signals to said alarm output terminal from both a circuit breaker connected to said circuit breaker alarm terminals and a fuse connected to said fuse alarm terminal.

19. The power distribution unit as recited in claim 15 further including a plurality of said protection receptacles.

20. The power distribution unit as recited in claim 15 further comprising an alarm switching matrix configured to identify either a tripped circuit breaker or a cleared fuse coupled to said protection receptacle.
